(19) United States
(12) Patent Application Publication
(10) Pub. No.: US 2018/0017749 A1
(43) Pub. Date: Jan. 18, 2018

(54) OPTICAL FIBER CABLE ASSEMBLY

(71) Applicants: Amphenol Fiber Optic Technology (Shenzhen) Co., Ltd., Shenzhen City (CN); Haowave Cable (Shenzhen) Co., Ltd., Shenzhen City (TW)

(72) Inventors: Linghua ZHU, Shenzhen City (CN); Songsheng LI, Shenzhen City (CN); Xuewu LEI, Shenzhen City (CN); Jinan ZHOU, Shenzhen City (CN); Pai-Hsiang CHIANG, Shenzhen City (CN)

(21) Appl. No.: 15/443,387

(22) Filed: Feb. 27, 2017

(30) Foreign Application Priority Data
Jul. 15, 2016 (TW) 105210644

(51) Int. Cl. G02B 6/44

(52) U.S. Cl. CPC G02B 6/4432; G02B 6/4479

(57) ABSTRACT

An optical fiber cable assembly includes a core sheath defining an installation space that is formed therethrough along length thereof, an auxiliary thread extending through the installation space, and having opposite first and second end sections that respectively extend out of two ends of the core sheath, and at least one core connected to the first end section of the auxiliary thread, such that the second end section of the auxiliary thread can be pulled outwardly to move the core into the core sheath.

### CROSS-REFERENCE TO RELATED APPLICATION

This application claims priority of Taiwanese Patent Application No. 105210644, filed on Jul. 15, 2016.

### FIELD

The disclosure relates to an optical fiber cable assembly, and more particularly to an optical fiber cable assembly that includes cores which are easy to be moved in a core sheath during a manufacturing process.

### BACKGROUND

As shown in FIG. 1, a conventional optical fiber cable assembly 1 includes a core sheath 10 defining an installation space 100 that is formed therethrough along length thereof, a plurality of cores 11 extending through the installation space 100, an outer jacket 12 disposed around the core sheath 10 to form a filling space 120 therebetween, and a plurality of Kevlar fibers 13 disposed in the filling space 120 and extending along the length of the core sheath 10. The Kevlar fibers 13 are Aramid fibers which have high tensile strength, high thermal resistance, and high resistance to organic solvent erosion. Therefore, even if the optical fiber cable assembly 1 is stretched or bent, the deformation of the core sheath 10 is limited by the Kevlar fibers 13, so that the cores 11 disposed inside the installation space 100 are under protection.

The manufacturing process of the optical fiber cable assembly 1 includes a step of moving the cores 11 into the installation space 100 of the core sheath 10. To satisfy market demand, the optical fiber cable assembly 1 is long. However, since the long cores 11 are flexible, it is difficult to move the long cores 11 into the installation space 100.

Therefore, to prevent waste of human resource and a time-consuming process, and to improve the manufacturing quality, it is important to find an efficient way to solve the above-mentioned problem.

### SUMMARY

Therefore, the object of the disclosure is to provide an optical fiber cable assembly that includes cores which can be moved easily into a core sheath.

According to the disclosure, the optical fiber cable assembly includes a core sheath defining an installation space that is formed therethrough along length thereof, an auxiliary thread extending through the installation space, and having opposite first and second end sections that respectively extend out of two ends of the core sheath, and at least one core connected to the first end section of the auxiliary thread, such that the second end section of the auxiliary thread can be pulled outwardly to move the core into the core sheath.

### BRIEF DESCRIPTION OF THE DRAWINGS

Other features and advantages of the disclosure will become apparent in the following detailed description of the embodiment with reference to the accompanying drawings, of which:

FIG. 1 is a sectional view of a conventional optical fiber cable assembly;

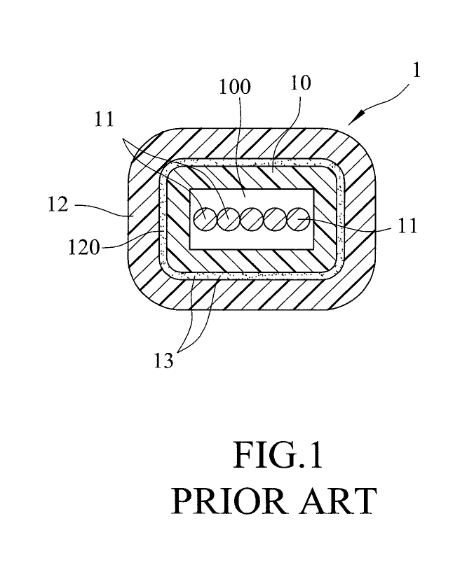

FIG. 2 is a schematic partially exploded perspective view of an embodiment of an optical fiber cable assembly according to the disclosure;

FIG. 3 is a sectional view of the embodiment;

FIG. 4 is a schematic perspective view of the embodiment illustrating that one of cores is connected to an auxiliary thread in a radial direction thereof;

FIG. 5 is a view similar to FIG. 4, illustrating that the cores are pulled by the auxiliary thread to move into a core sheath; and

FIG. 6 is a view similar to FIG. 4 but illustrating that one of the cores is connected to the auxiliary thread in an axial direction thereof.

### DETAILED DESCRIPTION

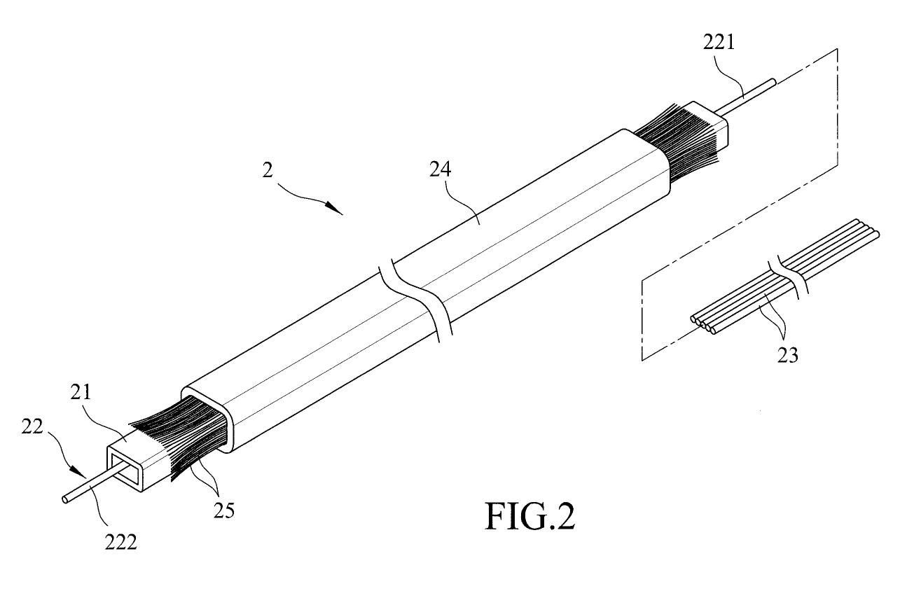

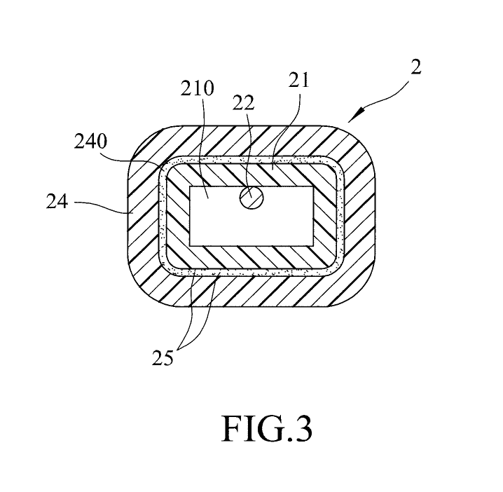

Referring to FIGS. 2 and 3, the embodiment of an optical fiber cable assembly 2 according to the disclosure includes a core sheath 21 defining an installation space 210 that is formed therethrough along length thereof, an auxiliary thread 22 extending through the installation space 210, at least one core 23 connected to the auxiliary thread 22, an outer jacket 24 disposed around the core sheath 21 to form a filling space 240 therebetween, and a plurality of tensile fibers 25 disposed in the filling space 240 and extending along the length of the core sheath 21. In this embodiment, the optical fiber cable assembly 2 includes a plurality of cores 23, and the tensile fibers 25 are Kevlar fibers. The Kevlar fibers have excellent tensile strength, so that the embodiment has high tensile strength.

The auxiliary thread 22 is disposed in the installation space 210 when manufacturing the core sheath 21. The auxiliary thread 22 has opposite first and second end sections 221, 222 that respectively extend out of two ends of the core sheath 21. It should be noted that, each of the first and second end sections 221, 222 needs to have a sufficient length to facilitate connection with the cores 23, and appropriate lengths of the first and second end sections 221, 222 depend on the operating conditions.

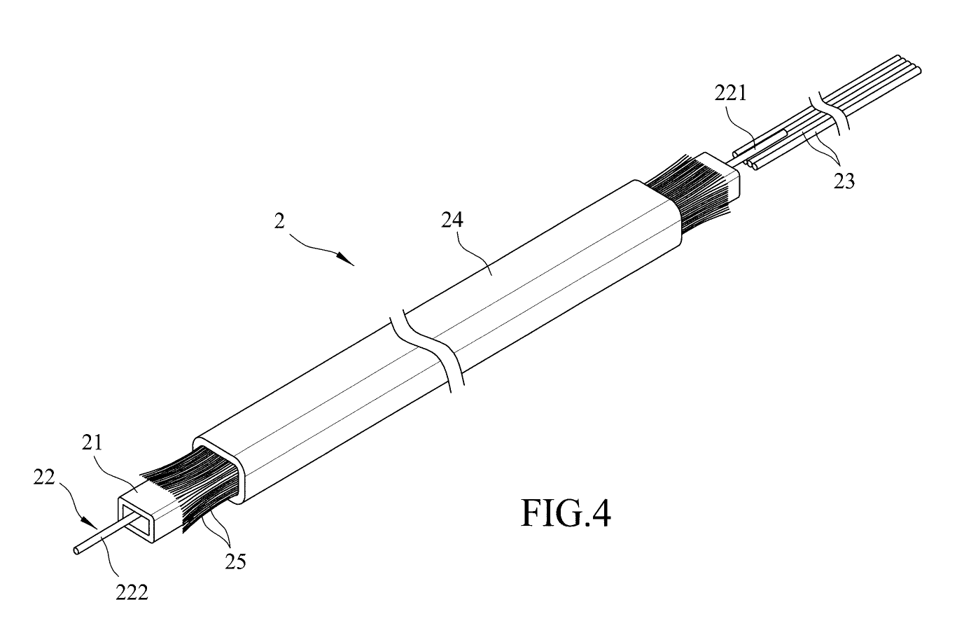

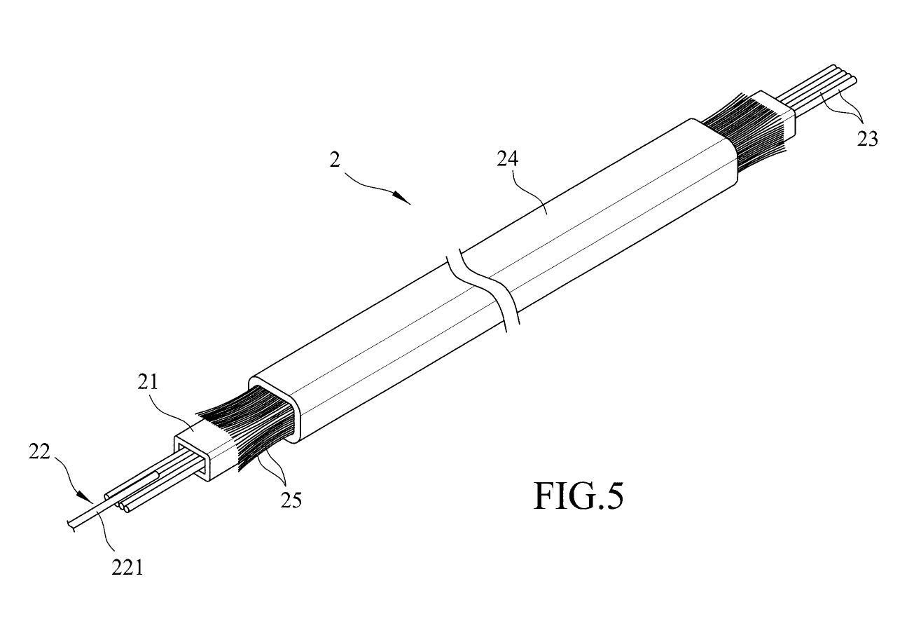

As shown in FIGS. 4 and 5, the cores 23 are juxtaposed, are interconnected, and are connected to the first end section 221 of the auxiliary thread 22 in a radial direction, such that the second end section 222 of the auxiliary thread 22 (see FIG. 4) can be pulled outwardly from the installation space 210 to move the cores 23 into the core sheath 21. As shown in FIG. 5, when the auxiliary thread 22 is pulled out of the installation space 210, the cores 23 are disposed in the core sheath 21. Thus, the object of the disclosure can be achieved.

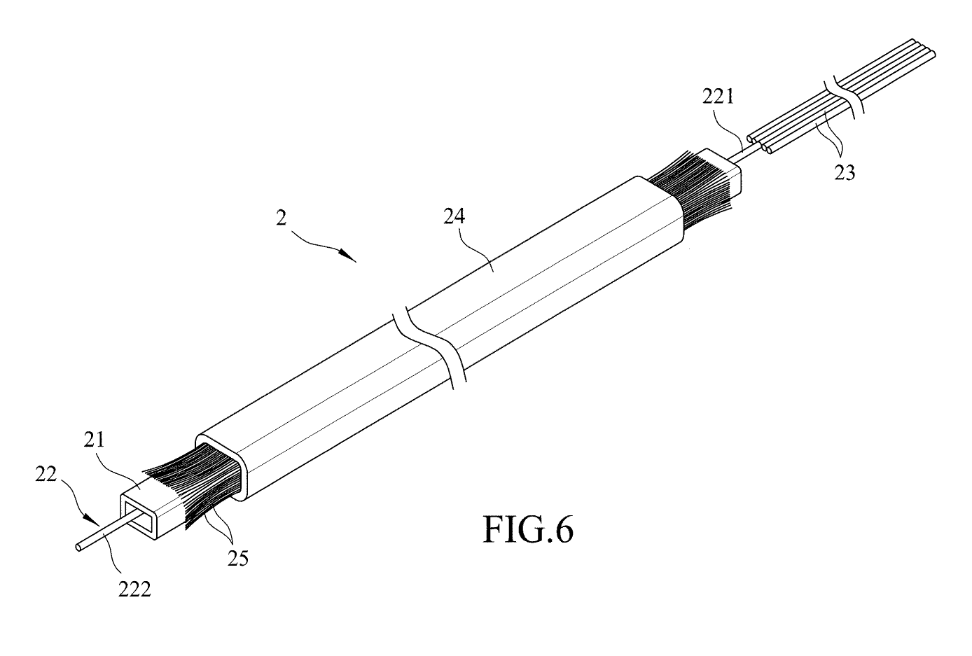

Referring to FIG. 6, the cores 23 may be connected to the auxiliary thread 22 in an axial direction. If it occurs, the object of the disclosure can also be achieved.

In conclusion, with the disposition of the auxiliary thread 22, the cores 23 can be smoothly moved into the core sheath 21 during an installing operation. Therefore, the process for manufacturing the optical fiber cable assembly 2 is labor-saving, and the manufacturing quality is improved.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. An optical fiber cable assembly comprising:
a core sheath defining an installation space that is formed therethrough along a length thereof;
an auxiliary thread extending through said installation space, and having opposite first and second end sections that respectively extend out of two ends of said core sheath; and
at least one core connected to said first end section of said auxiliary thread, such that said second end section of said auxiliary thread can be pulled outwardly to move said core into said core sheath;
wherein said auxiliary thread is connected to said core in a radial direction of said auxiliary thread.

2. The optical fiber cable assembly as claimed in claim 1, further comprising:
an outer jacket disposed around said core sheath to form a filling space therebetween; and
a plurality of tensile fibers disposed in said filling space and extending along the length of said core sheath.

3. The optical fiber cable assembly as claimed in claim 1, wherein said core is connected to said auxiliary thread in a radial direction of said core.

4. (canceled)

5. The optical fiber cable assembly as claimed in claim 2, wherein said tensile fibers are Kevlar fibers.
